(19) United States
(12) Patent Application Publication
(10) Pub. No.: US 2024/0136996 A1
(43) Pub. Date: Apr. 25, 2024

(54) SYSTEMS AND METHODS FOR GENERATING AN OPTIMIZED ACOUSTIC WAVE (AW) RESONATOR USING THE FINITE ELEMENT TEARING AND INTERCONNECTING (FETI) METHOD

(71) Applicant: Murata Manufacturing Co., Ltd., Nagaokakyo-shi (JP)

(72) Inventors: Hongliang Li, Urbana, IL (US); Jianming Jin, Champaign, IL (US); Julius Koskela, Helsinki (FI); Jackson Massey, Austin, TX (US); Balam Willemsen, Brookline, MA (US)

(21) Appl. No.: 18/486,699

(22) Filed: Oct. 13, 2023

Related U.S. Application Data
(60) Provisional application No. 63/416,108, filed on Oct. 14, 2022.
(60) Provisional application No. 63/451,260, filed on Mar. 10, 2023.

(51) Int. Cl. H03H 9/02

(52) U.S. Cl. CPC H03H 9/02015; H03H 9/02086

(57) ABSTRACT

Techniques described herein relate to systems and methods for generating an optimized acoustic wave (AW) structure, including: receiving, by a computing system, a set of frequency response requirements and a physical model of the AW structure; partitioning the physical model into a plurality of subdomains that are non-overlapping; determining and applying transmission conditions (TCs) for each of the plurality of subdomains to couple neighboring subdomains; reducing a subdomain problem for each subdomain of the plurality of subdomains to a local interface problem; assembling degrees of freedoms (DOFs) from all local interface problems to form a global interface system; solving the global interface system by monitoring for convergence accelerated by the applied TCs; deriving a frequency response of the AW structure at least partially from the solved global interface system; comparing the frequency response to the set of frequency response requirements; and optimizing the AW structure based on the comparison.

### CROSS-REFERENCE TO RELATED APPLICATIONS

This application claims the benefit of U.S. Provisional Application No. 63/416,108, filed on Oct. 14, 2022, and U.S. Provisional Application No. 63/451,260, filed Mar. 10, 2023, the contents of each of which are hereby incorporated by reference in their entireties.

### FIELD OF TECHNOLOGY

The present disclosure relates to the field of acoustic wave (AW) resonators, and, more specifically, to systems and methods for generating an optimized AW resonator using a finite element tearing and interconnecting (FETI) method.

### BACKGROUND

The rapid growth of the wireless communication industry has increased the demand for miniature filters with high power handling capabilities. For example, when comparing 4G technology to 5G technology, despite 5G offering performance improvements in services such as video streaming, 5G uses a larger bandwidth and higher frequencies of the radio frequency (RF) spectrum than 4G. Because higher frequencies do not propagate as well as lower frequencies, advanced RF filters are needed to ensure proper transmission. Quick and efficient development and deployment of such RF filters is crucial to keep up with the advances in the wireless communication industry as new designs with better performance need to be constantly tested and implemented.

For example, the Transversely-Excited Film Bulk Acoustic Resonator (XBAR) is utilized in filters for 5G instead of filters with a simple surface acoustic wave design that predominate in 4G. The XBAR is an acoustic resonator structure for use in microwave filters and includes an interdigital transducer (IDT) formed on a thin floating layer, or diaphragm, of a single-crystal piezoelectric material. The IDT includes a first set of parallel fingers, extending from a first busbar and a second set of parallel fingers extending from a second busbar. The first and second sets of parallel fingers are interleaved. A microwave signal applied to the IDT excites a shear primary acoustic wave in the piezoelectric diaphragm. XBAR resonators provide very high electromechanical coupling and high frequency capability. XBAR resonators may be used in a variety of RF filters including band-reject filters, band-pass filters, duplexers, and multiplexers. XBARs are well suited for use in filters for communications bands with frequencies above 3 GHz.

XBARs have been proposed and fabricated with low losses, few spurs and excellent coupling, and have demonstrated their potential as an ideal technology for wideband 5G and Wi-Fi filter designs. The structure of an XBAR is designed by evaluating several simulated designs based on fundamental physical models. Because the simulations match actual physical performance, a design that will best serve the 5G service, for example, may go straight to fabrication without trial and error.

Such acoustic wave (AW) resonators may be modelled using methods such as the finite element model (FEM), which solves the governing partial differential equations by meshing the geometry of the AW device into small elements, or hierarchical cascading technique (HCT), in which the geometry of a resonator is decomposed along one dimension into building blocks, the system matrices of which are cascaded with a hierarchical algorithm. However, the FEM suffers from a severe issue when used for 3D modeling of practical devices: a large number of degrees-of-freedom (DOFs) are required to obtain a high accuracy. For a typical AW resonator, the number of DOFs for one 3D unit cell containing a pair of electrodes can be over tens of millions. Simulation of an entire device with hundreds of fingers is very challenging. Likewise, the memory requirements and the complexity of HCT increase exponentially as the problem size increases in the cross-sectional dimension due to the dense matrices that are generated when connecting adjacent building blocks. The memory issue is particularly dire, as high computational speeds in 3D HCT are typically achieved with GPU computation, with relatively limited memory available. The capability of HCT to utilize massively parallel computation architectures is inherently limited due to the tree structure of the hierarchical cascading process.

There thus exists a need for a quicker and more efficient way of modelling AW resonators.

### SUMMARY

To address the shortcomings of conventional AW resonator modelling, aspects of the disclosure describe methods and systems for generating an optimized AW resonator using the finite element tearing and interconnecting (FETI) method. In particular, the present disclosure describes a method and system for determining efficient interface transmission conditions that accelerate convergence of the solution of the FETI algorithm applied to electro-acoustic simulation of AW resonators.

In one exemplary aspect, the techniques described herein relate to a method of generating an optimized acoustic wave (AW) structure, including: receiving, by a computing system, a set of frequency response requirements and a physical model of the AW structure; partitioning, by the computing system, the physical model into a plurality of subdomains that are non-overlapping; determining and applying, by the computing system, transmission conditions (TCs) for each of the plurality of subdomains to couple neighboring subdomains, wherein determining the TCs includes determining TC coefficients based on a mesh size, interface orientation, and material properties of the AW structure; reducing, by the computing system, a subdomain problem for each subdomain of the plurality of subdomains to a local interface problem via a direct sparse solver; assembling, by the computing system, degrees of freedoms (DOFs) from all local interface problems to form a global interface system; iteratively solving, by the computing system, the global interface system by monitoring for convergence accelerated by the applied TCs; deriving, by the computing system, a frequency response of the AW structure at least partially from the solved global interface system; comparing, by the computing system, the frequency response to the set of frequency response requirements; and optimizing, by the computing system, the AW structure based on the comparison to provide an optimized design, the optimized design configured as an input to a manufacturing process.

In another exemplary aspect, the techniques described herein relate to a design system for generating an optimized acoustic wave (AW) structure. In this aspect, the design system includes a processor; a user interface coupled to the processor; and memory storing a resonator modelling program that, when executed by the processor, causes the design system to perform actions comprising receiving, by the user interface, a set of frequency response requirements and a physical model of the AW structure; partitioning the physical model into a plurality of subdomains that are non-overlapping; determining and applying transmission conditions (TCs) for each of the plurality of subdomains to couple neighboring subdomains, wherein determining the TCs comprises determining TC coefficients based on a mesh size, interface orientation, and material properties of the AW structure; reducing a subdomain problem for each subdomain of the plurality of subdomains to a local interface problem via a direct sparse solver; assembling degrees of freedoms (DOFs) from all local interface problems to form a global interface system; solving the global interface system by monitoring for convergence accelerated by the applied TCs; deriving a frequency response of the AW structure at least partially from the solved global interface system; comparing the frequency response to the set of frequency response requirements; and optimizing the AW structure based on the comparison to provide an optimized design, the optimized design configured as an input to a manufacturing process.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating an optimized acoustic wave (AW) resonator using the finite element tearing and interconnecting (FETI) method.

FIG. 2 is a block diagram illustrating subdomain divisions of an exemplary resonator.

FIG. 3 illustrates a flow diagram of implementing the FETI method.

FIG. 4 is a block diagram illustrating convergence plots.

FIG. 5 illustrates a flow diagram of a method for generating an optimized acoustic wave (AW) resonator using the FETI method.

FIG. 6 presents an example of a general-purpose computer system on which aspects of the present disclosure can be implemented.

### DETAILED DESCRIPTION

Exemplary aspects are described herein in the context of a system, method, and computer program product for generating an optimized AW resonator using the finite element tearing and interconnecting (FETI) method. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

As described above, modelling and calculating the response of acoustic wave (AW) resonators is time consuming, processor heavy, and can even be inaccurate. When using the finite element model (FEM), the mathematical problems can quickly become too large to solve in terms of time and memory. Using the hierarchical cascading technique (HCT) to accelerate the FEM requires strict restrictions on the mesh for decomposing the problem.

To develop a more general efficient 3D FEM modeling of AW resonators, the present disclosure describes a robust domain decomposition scheme referred to as the FETI method. This method can be executed using a resonator modelling program, which is a software for designing and simulating performance of AW resonators. Although the FETI method has been successfully applied in a variety of electromagnetic (EM) and elastic problems, its application to acoustic wave resonators has not been implemented because the FETI algorithm, without carefully crafted interface transmission conditions (ITC), has poor convergence for the iterative solver, which results in long/impractical computation times.

In general, the FETI method decomposes the entire computational domain into non-overlapping subdomains, and enforces Robin boundary conditions or transmission conditions at subdomain interfaces to couple solutions across subdomains. The small subdomain problems are reduced to local interface problems via a direct sparse solver, and all interface DOFs are then assembled to form a global interface system. The global interface system is finally solved using an iterative solver such as the generalized minimal residual (GMRES) method with an effective preconditioner. Compared with the HCT, the FETI method provides several benefits. First, iterative solvers are configured to solve global interface systems, and direct sparse solvers are configured to solve inner subdomain problems. This alleviates burdens on memory usage, and reduces computational costs when the overall problem sizes are large. Second, factorization and local solution steps for each subdomain are independent, and communications are only required after each subdomain is solved, resulting in a high parallel efficiency. Finally, decomposition of computational domain can be arbitrary, and thus this method can be extended to 3D finite resonator modeling.

In the present disclosure, the FETI algorithm is implemented for efficient simulation of 3D periodic XBAR resonators (the same approach may also be applied to non-periodic cases). Due to the electro-mechanical coupling and anisotropic properties in piezoelectric materials, the resulting global interface system in FETI is found to be ill-conditioned, and the convergence of iterative solutions even with a robust Krylov subspace method is slow. To alleviate this issue, two approaches based on the construction of a higher-order transmission condition and the design of an effective preconditioner are proposed to accelerate the rate of convergence.

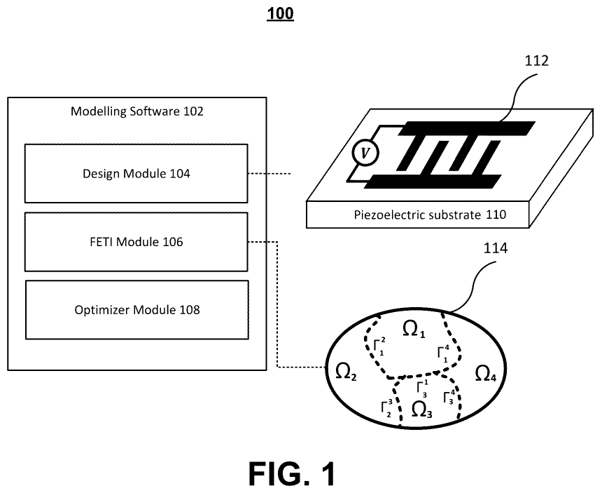

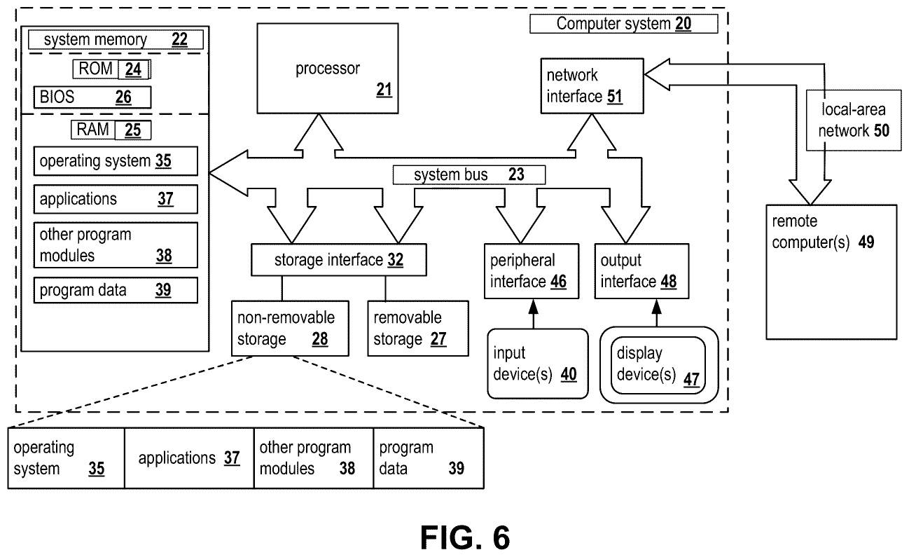

FIG. 1 is a block diagram illustrating system 100 for generating an optimized AW resonator using the FETI method. System 100 includes modelling software 102 that may be executed by processor 21 (described in FIG. 6). According to the exemplary aspect, modelling software 102 is configured to output an optimized AW resonator design that can be effectively used in the wireless communication industry. In an exemplary aspect, the optimized design may serve as an input to a manufacturing process, such as fabrication method, for producing the optimized AW resonator.

Modelling software 102 includes design module 104, which receives a set of frequency response requirements, such as insertion loss, return loss, and out-of-band rejection, and a physical model of the AW resonator. In an exemplary aspect, these parameters can be entered by a user interface, for example. For example, the system 100 can include a user interface 120 communicatively coupled to (or included with) modelling software 102. User interface 120 can be configured to receive information and data from a user (e.g., parameter values defining the physical model of the AW resonator and/or resonator requirements) and to output frequency-dependent characteristics of the AW resonator and filter to the user. Moreover, as described in more detail below, a system memory can be provided that is configured for storing the modelling software 102 (which may take the form of software instructions, which may include, but are not limited to, routines, programs, objects, components, data structures, procedures, modules, functions, and the like that perform particular functions or implement particular abstract data types), as well as the information and data input from the user via the user interface 120; and a processor configured for executing the modelling software 102.

As mentioned previously, the AW resonator may include an interdigital transducer (IDT). In some aspects, the IDT pitch is several times the plate thickness, and the resonance frequency scales inversely with the plate thickness. In operation, an alternating voltage is applied to the electrodes, and the responses of the resonator can be characterized by the admittance parameter in the time-harmonic domain. FIG. 1 includes an example of an AW resonator model 112, which includes electrodes on piezoelectric substrate 110.

FETI module 106 (e.g., a resonator modelling program or a portion of one) is configured to apply the FETI method on AW resonator model 112. The FETI algorithm is a divide-and-conquer technique that allows efficient simulation of complex acoustic resonator structures. The accurate simulation of AW resonators requires modeling piezoelectric material behavior with a strong coupling between electric and mechanical field variables. According to the exemplary aspect, the FETI algorithm is configured to divide the entire structure into smaller pieces (e.g., subdomains) that can be handled easily, as illustrated in FIG. 1.

In an exemplary aspect of the domain decomposition, the computational domain Ω 114 is decomposed into many subdomains Ω^{p} (p=1, 2, . . . , Nₚ), whose boundaries are denoted as ∂Ω^{p}. For each ∂Ω^{p}, the portion that interfaces with neighboring subdomain Ω^{q} is denoted as Γ_{q}^{p}. The subdomain problems will be solved directly and independently, and a global interface problem will be formulated to interconnect all subdomains and solved iteratively.

Optimizer module 108 is configured to take the output of FETI module 106 and generate an optimized design accordingly.

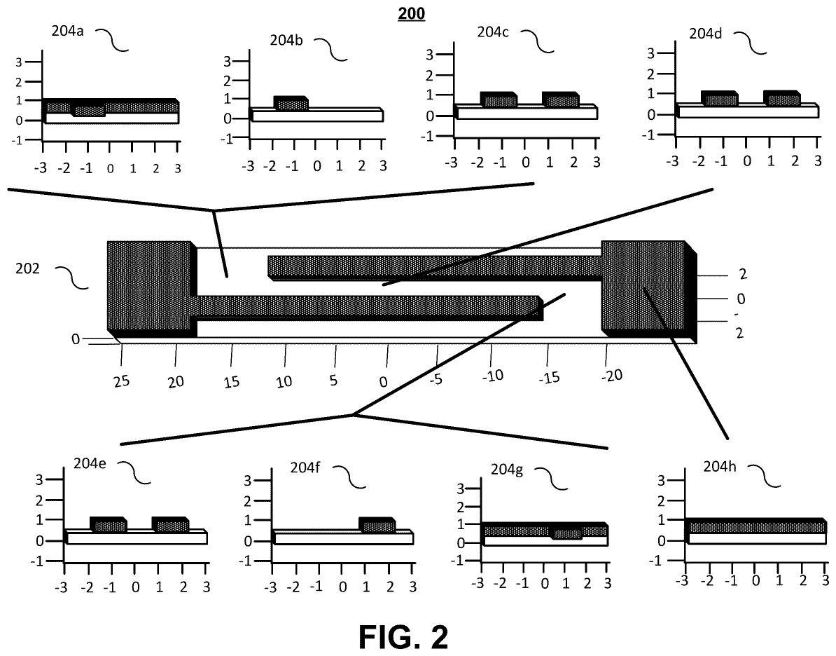

FIG. 2 is a block diagram 200 illustrating subdomain divisions on the actual AW resonator model. Consider domain 202 to be the entirety of the AW resonator model, which can be loaded or set by a user to modelling software 102, in an exemplary aspect. FETI module 106 determines subdomains 204a, 204b, 204c, 204d, 204e, 204f, 204g, and 204h. It should be noted that the amount of subdomains shown is exemplary and limited for simplicity. A person skilled in the art will appreciate that FETI module 106 may determine a larger or smaller amount of subdomains depending on the input model. For example, because the width of the electrode is uniform from region 15 to −15, all subdomains between the area will be identical and therefore several subdomains do not need to be identified for that region. Accordingly, partitioning the physical model comprises scanning the physical model for unique cross sections and identifying each unique cross section as a respective subdomain. FETI module 106 can be configured to arbitrarily determine subdomains 204a to 204h in an exemplary aspect. In some aspects, FETI module 106 begins a scan of the physical model along an axis (e.g., a z-axis) and identifies a first cross section at a first point (e.g., z=18 on FIG. 2 corresponds to subdomain 204a). FETI module 106 identifies this first cross section as a subdomain and continues the scan. At a second point (e.g., z=15 on FIG. 2 corresponds to 204b), FETI module 106 identifies a second cross section. In response to determining that the first cross section and the second cross section do not match, FETI module 106 identifies the second cross section as another subdomain and continues the scan. Suppose that after identifying subdomain 204a, 204b, and 204c, FETI module 106 arrives at a point corresponding to subdomain 204d. In this case, FETI module 106 may determine that subdomain 204c and 204d match. In order to reduce the number of copies and not increase computational load, FETI module 106 may determine whether there are more than a threshold number of copies of a particular subdomain. For example, FETI module 106 may determine that no more than three copies of a particular subdomain should exist. Accordingly, traversing the example in FIG. 2, FETI module 106 may select subdomains 204c, 204d, and 204e for computational purposes, but may not select addition matching subdomains (e.g., any other subdomain between 12 and −14).

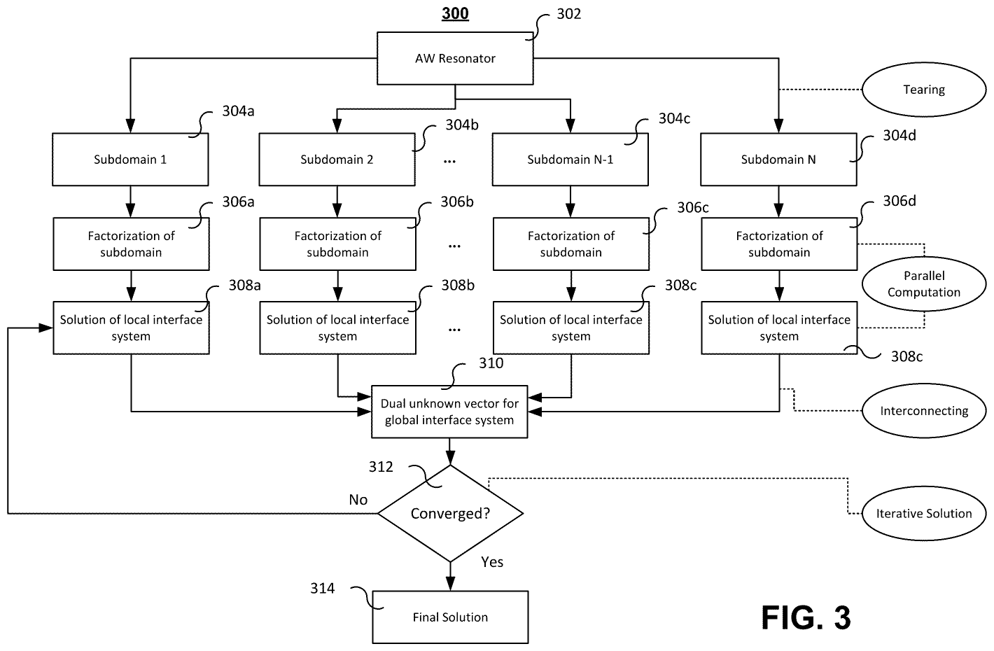

FIG. 3 illustrates a flow diagram 300 of implementing the FETI method. FETI module 106 executes 4 general steps: tearing, parallel computation, interconnecting, and iterative solutions in order to reach final solution 314 for an input AW resonator model 302. Tearing involves decomposing the device model into smaller subdomains 1-N and reducing the subdomains into local interface problems (e.g., subdomain boundary problems). FIG. 3 depicts N decomposition steps (include 304a, 304b, 304c, and 304d). FETI module 106 then factorizes each subdomain (steps 306a, 306b, 306c, 306d) and determines solutions for each local interface system (steps 308a, 308b, 308c, and 308d). Steps 306 and 308 are part of parallel computation. Subsequently, FETI module 106 performs interconnecting at step 310, where the FETI module 106 determines a dual unknown vector for a global interface system. Parallel computation and interconnecting are performed by FETI module 106 until convergence is achieved at step 312. As will be discussed in greater detail below, the FETI algorithm uses a transmission condition that allows wave modes to propagate between neighboring subdomains and connects those subdomains in the global interface system.

Since the FETI method decomposes a structure into many subdomains and couples neighboring subdomains through transmission conditions (TCs), the convergence of the iterative FETI solution depends highly on the performance of the enforced TCs. To achieve fast convergence, the TCs have to absorb reflected waves from boundaries so that they are as transparent as possible for waves transmitting across the interfaces. For simple first-order TCs, only propagating waves are treated (e.g., absorbed), and evanescent modes are untreated. Additionally, several modes or polarizations of mechanical displacement fields and electric potentials can be present due to the anisotropic properties of piezoelectric materials, causing the derivation of efficient TC coefficients to be nontrivial. For this, an analytical convergence analysis is first performed, and a second-order TC (SOTC) is carefully designed to account for both propagating and evanescent modes. With the proposed SOTC, the number of iterations can be reduced by a factor of 2. To further accelerate the convergence, preconditioning techniques can be adopted to improve the conditioning of the system matrices. The exemplary aspects of the present disclosure describe the use of a forward-backward preconditioner (FBP) that takes no additional costs and can reduce the number of convergence by at least an additional factor of 2. With the combination of the SOTC and the FBP, the convergence of the FETI algorithm is improved significantly, resulting in efficient numerical modeling of XBAR resonators.

The FEM system matrix can be formulated within each subdomain except that a surface integration over the interfaces with neighboring subdomains will be added to the right-hand side (RHS). The neighboring subdomains are interconnected by these surface integration terms. A natural choice is to enforce certain natural boundary conditions to specify the surface stresses and charges on the interfaces. However, it has been shown in the EM community that this will result in ill-conditioned global system matrices in high-frequency wave propagation problems when domain decomposition algorithms are applied, which leads to poor convergence for an iterative solution.

A remedy is to apply Robin boundary conditions or transmission conditions (TCs) to absorb reflected waves from the interfaces and make the boundaries as transparent as possible for the fields propagating across the interfaces. With this, the influence of the interfaces can be minimized to the subdomain problems so that each subdomain can converge quickly to the original problem solutions when solved iteratively.

To derive the form of the TCs for piezoelectric materials, consider a scalar wave incident onto a y-plane. If there is no reflection, the wave can be written as ψ=ψ₀exp{−jkₓx−jk_{y}y−jk_{z}z}, and its normal derivative satisfies the relation:

∂_{y}ψ=∂_{y}ψ=−jk_{y}ψ (1)

which is exactly an absorbing condition or TC if k_{y} is known. Here, k represents a wave number, which is a reciprocal of the wavelength. In general, ∂ₜ and ∂ᵢ are the derivatives with respect to time and space, respectively. Since waves can propagate in arbitrary directions in a real device, TC can only be approximated as:

∂ₙψ+αψ=f (2)

where f is a source term induced at the subdomain interfaces. It should be mentioned that, although this is an approximate TC, it will give accurate solutions for the FETI algorithm, and the coefficient α only affects the convergence performance in an iterative solver. It can be proven that the TC related terms will cancel out when neighboring subdomains are summed to form a global domain problem, and the resulting system is exactly the same as the original FEM system for the entire domain. TCs for piezoelectric materials enforced at subdomain interfaces are expected to take the form:

nⱼTᵢⱼ+αᵢⱼ^{u}uⱼ=fᵢ^{u}

nᵢDᵢ+α^{φ}φ=f^{φ} (3)

where the coefficients α's are to be determined. Here, where uⱼ is the jth component of mechanical displacement \vec{u} and Dᵢ is the ith (i=1, 2, or 3) component of electric displacement \vec{D}, along the x-, y-, and z-directions. Tᵢⱼ is the stress tensor and φ is the electric potential. Together, nⱼTᵢⱼ represents surface forces and nᵢDᵢ represents surface charges enforced on the boundaries. Here it is assumed that the coefficients are already found such that the TCs have a good absorption of elastic waves propagating across the interfaces. To abbreviate the notation, the displacements and electric potential are collected into a generalized displacement field:

\vec{u}^{G}:={\vec{u}^{T},φ}^{T}. (4)

In some aspects, a first-order TC and a second-order TC take a form of:

nᵢ\vec{T}ᵢ^{G}+α̅·\vec{u}^{G}=\vec{f}^{G}

nᵢ\vec{T}ᵢ^{G}+α̅·\vec{u}^{G}+β̅·∂_{τ}²\vec{u}^{G}=\vec{f}^{G},

wherein α and β are coefficients, \vec{u}^{G} is the generalized mechanical displacement, \vec{T}ᵢ^{G} is the generalized stress tensor.

It is also convenient to define stress forces as:

\vec{T}ᵢ:=T̅·\vec{e}ⁱ={Tₓᵢ,T_{yi},T_{zi}}^{T} (5)

where \vec{e}ⁱ is a vector with only the ith component equal to one and zeros elsewhere. The generalized stress forces may be defined as

\vec{T}ᵢ^{G}:={\vec{T}ᵢ^{T},Dᵢ}^{T} (6)

With the notation introduced above, the TCs in (3) can be expressed in a compact form as:

nᵢ\vec{T}ᵢ^{G}+α̅·\vec{u}^{G}=\vec{f}^{G}. (7)

The electro-acoustic problem for acoustic wave resonators can have wave propagation in arbitrary directions (making kₓ, k_{y}, k_{z} unknown a priori) and the substrate has anisotropic material properties, making it challenging to consistently choose an α̅ for the transmission condition that yields good convergence for the iterative solution of the global interface system.

At this stage, the TC has been used in the FETI algorithm and convergence analysis, but the coefficients in the TC are not determined yet. FETI module 106 derives a first-order TC (FOTC) for a given piezoelectric material and performs convergence analysis. For a 3D periodic simulation of AW resonators, the structures along the aperture direction can be truncated, and the interfaces can be considered parallel to the y-plane. In this case, nᵢ\vec{T}ᵢ^{G} in the TC in (7) is reduced to \vec{T}_{y}^{G}. From the definition of the generalized stress tensor, \vec{ }\vec{T}_{y}^{G} may be expressed as the spatial derivatives of \vec{u}^{G} in a compact form as:

\vec{T}_{y}^{G}=(C̅_{yx}·∂ₓ+C̅_{yy}·∂_{y}·C̅_{yz}·∂_{z})\vec{u}^{G}. (8)

Here, C̅ represents a particular elastic constant. Assume plane wave propagation \vec{u}^{G}=\vec{u}^{G}₀ exp{−jkᵢxᵢ} with a wavenumber kₓ²+k_{y}²+k_{z}²=k₀². For normal incidence of elastic waves onto the interfaces (∂x=∂z=0), the relation in (8) can be approximated as

\vec{T}_{y}^{G}≈C̅_{yy}·∂_{y}\vec{u}^{G}=−jk_{y}C̅_{yy}\vec{u}^{G}≈−jk₀C̅_{yy}\vec{u}^{G} (9)

By comparing with the TC in (7), it can be determined that

$$\overline{\overline{α}} = j {k}_{0} {\overline{\overline{C}}}_{yy} \qquad ( 10 )$$

$$where {\overline{\overline{C}}}_{yy} = \begin{matrix}{C}_{66} & {C}_{62} & {C}_{64} & {e}_{26} \\ {C}_{26} & {C}_{22} & {C}_{24} & {e}_{22} \\ {C}_{46} & {C}_{42} & {C}_{44} & {e}_{24} \\ {e}_{26} & {e}_{22} & {e}_{24} & - {ϵ}_{22}\end{matrix} \qquad ( 11 )$$

Here, eᵢⱼ represents a particular piezoelectric constant and ϵᵢⱼ represents a particular permittivity constant. The wavenumber in the transmission coefficients is not known yet, and it depends on the materials. To determine the coefficient k₀, the elastic plane wave solutions are examined. For piezoelectric materials, three bulk acoustic wave modes or polarizations are supported due to the anisotropic properties, namely, the quasi-longitudinal (QL), quasi-shear vertical (Q-SV), and quasi-shear horizontal (Q-SH) modes, which can be obtained by solving an eigenvalue problem using a Christoffel equation.

The slownesses s=1/v=k/ω not only depend on a certain bulk wave mode, but also vary strongly with the propagation angle ϑ. Through numerical experiments, it can be found that relatively faster convergence can be obtained when k₀ is chosen to be the wavenumber corresponding to normal incidence (y-incidence in our case) of the quasi-longitudinal mode, such that

k_{0,TC}=ωs_{y,QL|sx=0,sz=0}. (12)

For electro-acoustic problems, due to the periodic excitation of electric voltages along the lateral direction, the electric potential φ has a wavenumber k_{x,vol}=2π/λₓ along the x-direction. Because of the electro-static property, the electric potential satisfies the dispersion relation kₓ²+k_{y}²=0 for the XY-plane incidence, and φ decays along the y direction. Therefore, under the plane wave assumption, the phase velocity of φ should have a pure imaginary value, and it is found that k_{y,φ}=−jk_{x,vol} gives the best performance.

Finally, the coefficients in FOTC (7) are chosen as

α̅_{FOTC}=C̅_{yy}·diag{jk_{0,TC},jk_{0,TC},jk_{0,TC},k_{x,vol}} (13)

Based on these coefficient values, a convergence analysis on the FOTC can be performed and a convergence factor as a function of wavenumber kₓ can be computed. Consider an XY-incidence (k_{z}=0) in a ZY-cut LiNbO3. As kₓ/k₀ approaches 0, which corresponds to normal incidence onto the interface, convergence factor r approaches 0 and very fast convergence can be expected for a stationary iterative solution. This is expected since the FOTC coefficients are derived under normal incident wave assumption. However, as kₓ/k₀ approaches 1, which corresponds to grazing incidence to the interface, convergence factor r increases to 1 dramatically, and an iterative solution will not converge or will converge in a very slow rate. This means the FOTC cannot absorb waves that travel tangentially along the interface. In practical devices, acoustic waves may propagate with arbitrary incident angles. It may be expected that the convergence factor for the FOTC falls between 0 and 1, and a reasonable convergence rate can be achieved using an iterative solver, especially with a Krylov subspace solver.

It is noted that when kₓ/k₀>0, which corresponds to the evanescent mode regime, convergence factor is always r=1. This implies that the FOTC only absorbs propagating waves and it cannot take care of evanescent waves. For this, a higher-order transmission condition can be designed to reduces the convergence factor below 1 in the evanescent region kx/k0>1.

This issue can be addressed in the computational electromagnetics area where second-order TCs (SOTCs) are proposed for isotropic materials to further improve the convergence performance in non-overlapping Schwarz algorithms. However, the study of higher-order TCs for solving electro-mechanical problems with piezoelectric materials has not been reported.

To design a SOTC, a dispersion relation should be reviewed, namely, k_{⊥}=\sqrt{k₀²−k_{τ}²}, where subscript ⊥ denotes normal direction, and τ denotes tangential components. A careful examination of the FOTC reveals that it is equivalent to a first-order approximation of the dispersion relation k_{⊥}≈k₀ or ∂_{⊥}≈−jk₀, and the tangential components are completely ignored. For a better approximation, tangential terms can be added such as k_{⊥}≈k₀−γk_{τ}² or ∂_{⊥}≈−jk₀−γd_{τ}². With this, the SOTC on the interface becomes

nᵢ\vec{T}ᵢ^{G}+α̅·\vec{u}^{G}+β̅·∂_{τ}²\vec{u}^{G}=\vec{f}^{G} (14).

For the SOTC, α̅_{SOTC}=α̅_{FOTC} is chosen to obtain a similar convergence rate for propagating modes, which gives additional freedom to choose β̅ for the second-order tangential differential terms. This parameter is mainly to accelerate the convergence for evanescent modes. Let k_{τ}^{max}=π/hₘᵢₙ where hₘᵢₙ is the minimum mesh size across the interface, and k_{τ}^{max} represents the maximum transverse wavenumber supported by the numerical grid. From the dispersion relation, \tilde{k}_{⊥}−j\sqrt{(k_{τ}^{max})²−k_{0,TC}²} is obtained. By setting γ_{TC}=j/(k_{0,TC}+\tilde{k}_{⊥}) an approximate ∂,⊥ operator is obtained in terms of k₀ and the second-order tangential differential operator as

∂_{⊥}\vec{u}^{G}≈(−jk_{0,TC}−γ_{TC}∂_{τ}²)\vec{u}^{G} (15).

In this case, ∂_{⊥}=∂_{y}. Substituting (15) into (9), β̅ may be determined. Again, due to the electro-static property of electric potentials, k₀=0 for φ, and therefore, γ_{TC,φ}=−1/k_{τ}^{max}. Finally, the SOTC coefficients are determined as

α̅_{SOTC}=C̅_{yy}·diag{jk_{0,TC},jk_{0,TC},jk_{0,TC},k_{x,vol}} (16)

and

β̅_{SOTC}=C̅_{yy}·diag{γ_{TC},γ_{TC},γ_{TC},−1/k_{τ}^{max}} (17)

On a high-level, for SOTC, FETI module 106 selects an optimal α̅ and β̅ for the second-order interface transmission condition based on the mesh size (e.g., hₘᵢₙ) of the substrate, interface orientation (e.g., the normal direction of interfaces (x-direction, y-direction, etc.)), and material properties (e.g., the substrate having anisotropic material properties).

In convergence factor curves for XY-incident bulk acoustic waves in the ZY-cut LiNbO3 using the SOTC, where the interface mesh density is set to be one sixth of the wavelength along the x-direction: hₘᵢₙ=λₓ/6 and kₓ/k₀=1, waves propagate in parallel to the interface, and the SOTC has no absorption and total reflections occur, which results in non-convergence. In both the propagating and evanescent regions, a convergence factor is obtained that is much smaller than one, which translates to a faster convergence rate in an iterative solver.

Consider the following numerical example of an XBAR resonator generated by FETI module 106. The example used is a laterally excited bulk AW resonator (XBAR), with unit cell on a 400 nm thick)(0,0,90°)-LiNbO3 platelet. The electrodes on the membrane have a periodicity of λ=6.5 μm, thickness of 500 nm, and width of 0.887 μm, and the aperture is 30 μm. The computational domain is meshed with 24 elements along the lateral direction. Along the thickness direction, the piezoelectric layer is meshed to 4 elements, and the vacuum regions are meshed with 10 elements below and above the substrate. The unit cell is assumed to repeat infinitely, and periodic boundary conditions are applied along the lateral direction. In this simulation, PMLs are removed and the two ends of the bus bars are terminated with stress-free boundary conditions. For the reference solution using HCT, the device is decomposed into 260 thin slices along the aperture direction (y-direction), and the maximum number of DOFs on the interfaces is 2112. For the FETI method, the computational domain is decomposed into 26 subdomains, with 20000-25000 DOFs per subdomain. The GMRES is configured to solve the global interface system formulated with FOTC, and a direct sparse solver is configured to factorize the subdomain matrices and obtain local solutions.

To accelerate the convergence, one way is to design higher order TCs as discussed in previously. Another exemplary aspect is to construct an effective preconditioner for the iterative solver. In general, a preconditioning technique can improve the conditioning of system matrices and reduce the number of iterations. Instead of solving the original global interface system [F]{λ}={d}, a matrix [Pᵣ]⁻¹ can be adjusted/constructed to approximate the inverse operation of [F] cheaply and solve a new system [Pᵣ]⁻¹[F]{λ}=[Pᵣ]⁻¹{d} with a better-conditioned [Pᵣ]⁻¹[F].

The second term contains mutual coupling through subdomain interfaces. For a regular decomposition of structures, two sets of interfaces along opposite directions can be specified (i.e., forward and backward directions). The corresponding global interface matrices are defined as

[F⁺]=Σₚ[Q^{p}]^{T}Σ_{qϵnei+(p)}[T_{Γ}^{p}]_{q}^{T}([T_{Γ}^{q}]ₚ+[P_{Γ}^{q,p}][F_{Γ}^{q}])[Q^{q}] (18)

And

[F⁻]=Σₚ[Q^{p}]^{T}Σ_{qϵnei-(p)}[T_{Γ}^{p}]_{q}^{T}([T_{Γ}^{q}]ₚ+[P_{Γ}^{q,p}][F_{Γ}^{q}])[Q^{q}] (19)

Where nei+(p) and nei−(p) denote neighboring subdomains of Ω^{p} along the forward and backward directions, respectively. If the bi-directional interaction term is ignored, the following approximation is formed:

[F]=[I]+[F⁺]+[F⁻]≈([I]+[F⁺])([I]+[F⁻]) (20)

from which two left and right preconditioners can be formed:

[Pᵣ^{left}]⁻¹=([I]+[F⁺])⁻¹ (21)

and

[Pᵣ^{right}]⁻¹=([I]+[F⁻])⁻¹ (22).

If the DOFs for the interfaces are organized in a sequential order, it can be determined that [Pᵣ^{left}] is an upper triangular matrix and backward substitution is used to obtain the inverse operation very quickly. Similarly, [Pᵣ^{right}] is a lower triangular matrix, whose inverse can be obtained via a forward substitution.

The new preconditioned system then becomes:

[Pᵣ^{left}]⁻¹[F][Pᵣ^{right}]⁻¹([Pᵣ^{right}]⁻¹]{λ})=[Pᵣ^{left}]⁻¹{d} (23)

where [Pᵣ^{left}]⁻¹[F][Pᵣ^{right}]⁻¹ is expected to be well-conditioned. Compared with the original system, the total number of matrix-vector product operations in an iterative solver is doubled. To improve the efficiency and reduce the computational costs, the relation that

[F]=[Pᵣ^{left}]+[Pᵣ^{right}]−[I] (24)

can be exploited. With this, the matrix-vector product in the preconditioned system in (23) can be written as

{s}=[Pᵣ^{left}]⁻¹[F][Pᵣ^{right}]⁻¹{x}=[Pᵣ^{right}]⁻¹{x}+[Pᵣ^{left}]⁻¹{x}−[Pᵣ^{left}]⁻¹[Pᵣ^{right}]⁻¹{x} (25).

By defining

{t}=[Pᵣ^{right}]⁻¹{x} (26),

Equation (25) can be rewritten as:

{s}={t}+[Pᵣ^{left}]⁻¹({x}−{t}) (27).

In this exemplary aspect, a two-step matrix-vector product is involved in the iterative solver for the new preconditioned system. Because both left and right preconditioners are triangular matrices and only contain half entries of the entire matrix, the total number of operations is the same as that in the original global interface system. Therefore, the proposed preconditioners add no additional costs to the FETI algorithm. It should be noted that the proposed preconditions can be generalized and applicable to finite structures, not limited to the one-way decomposition pattern in periodic cases of one unit cell.

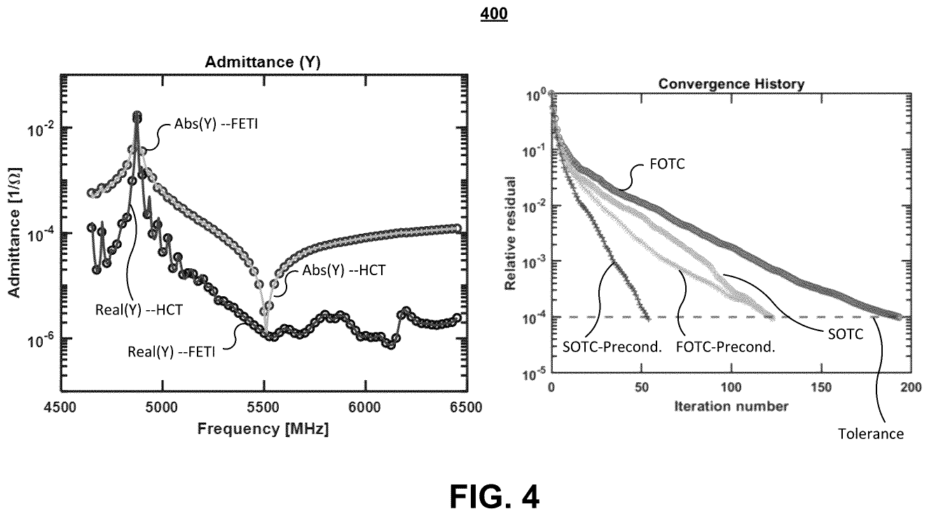

FIG. 4 is a block diagram 400 illustrating convergence plots. In diagram 400, the admittance plot shows Abs(Y)-FETI, which points to a plurality of circular icons that overlap with the line representing Abs(Y)-HCT. The convergence history plot shows FOTC, SOTC, SOTC precondition, and FOTC precondition curves. As can be seen, the admittance plot shows good agreement with HCT as the circles overlap with the line. The admittance curves would be the same for either FOTC or SOTC. The convergence history plot shows the faster convergence (i.e., fewer iterations required to achieve a desired relative residual of 10⁻⁴) of the FOTC, which requires 37% fewer iterations relative to the SOTC.

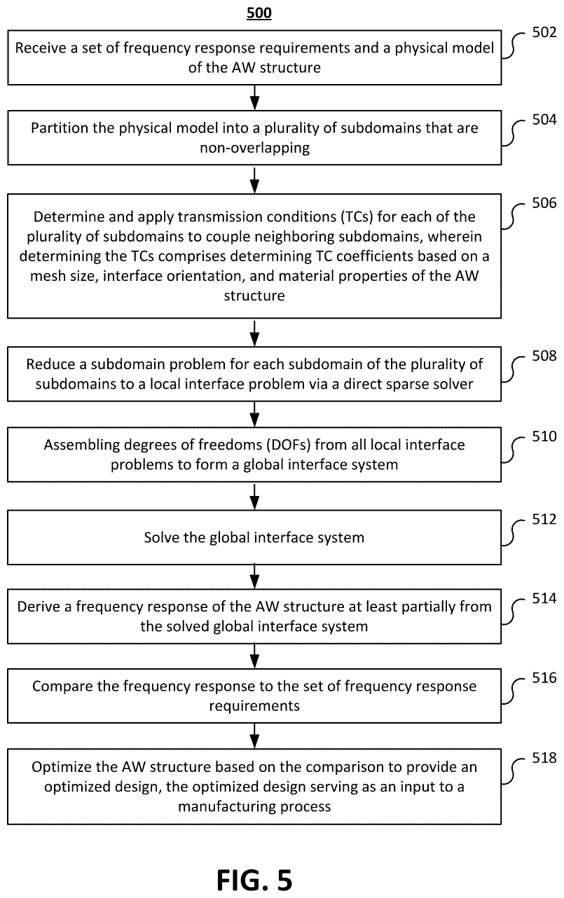

FIG. 5 illustrates a flow diagram of method 500 for generating an optimized acoustic wave (AW) resonator using the FETI method. At step 502, design module 104 receives a set of frequency response requirements and a physical model of the AW structure, which can be entered/set by a user via a user interface, for example. At step 504, FETI module 106 partitions the physical model into a plurality of subdomains that are non-overlapping (e.g., distinct from each other), and which can be set arbitrarily, for example. At step 506, FETI module 106 determines and applies transmission conditions (TCs) for each of the plurality of subdomains to couple neighboring subdomains, wherein determining the TCs includes determining TC coefficients based on a mesh size, interface orientation, and material properties of the AW structure. At step 508, FETI module 106 reduces a subdomain problem for each subdomain of the plurality of subdomains to a local interface problem via a direct sparse solver. At step 510, FETI module 106 assembles, by the computing system, degrees of freedoms (DOFs) from all local interface problems to form a global interface system. In general, DOFs refer to the unknowns/variables to be solved in the algorithm. At step 512, FETI module 106 solves the global interface system by monitoring for convergence accelerated by the applied TCs. Here, an iterative solver starts with an initial guess and calculates, via matrix vector multiplication, a residual that is used to form a next guess of the solution. Calculating residuals is repeated until the convergence is achieved. At step 514, FETI module 106 derives a frequency response of the AW structure at least partially from the solved global interface system. When convergence is achieved, frequency responses and field distributions will be the output values of the solver. The frequency responses (primarily) are then fed into the optimizer portion, which then outputs modification options such as changing the IDT thickness, substrate thickness, IDT spacing and/or other dimensions, etc.

At step 516, FETI module 106 compares the frequency response to the set of frequency response requirements. Finally, at step 518, optimizer module 108 optimizes the AW structure based on the comparison to provide an optimized design, the optimized design serving as an input to a manufacturing process.

FIG. 6 is a block diagram illustrating a computer system 20 on which aspects of systems and methods for generating an optimized AW resonator using the FETI method and associated algorithms, as described above, can be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 can be configured to execute one or more computer-executable code implementing the techniques (i.e., the resonator modelling program) and associated algorithms of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of generating an optimized acoustic wave (AW) structure, comprising:
receiving, by a computing system, a set of frequency response requirements and a physical model of the AW structure;
partitioning, by the computing system, the physical model into a plurality of subdomains that are non-overlapping;
determining and applying, by the computing system, transmission conditions (TCs) for each of the plurality of subdomains to couple neighboring subdomains;
reducing, by the computing system, a subdomain problem for each subdomain of the plurality of subdomains to a local interface problem;
assembling, by the computing system, degrees of freedoms (DOFs) from all local interface problems to form a global interface system;
solving, by the computing system, the global interface system by monitoring for convergence accelerated by the applied TCs;
deriving, by the computing system, a frequency response of the AW structure at least partially from the solved global interface system;
comparing, by the computing system, the frequency response to the set of frequency response requirements; and
optimizing, by the computing system, the AW structure based on the comparison to provide an optimized design, the optimized design that is configured as an input to a manufacturing process.

2. The method of claim 1, wherein factorization and local solution steps of the local interface problem for one subdomain of the plurality of subdomains are independent from factorization and local solution steps of the local interface problem for a different subdomain of the plurality of subdomains.

3. The method of claim 2, wherein the factorization and local solution steps of the one subdomain and the factorization and local solution steps of the different subdomain are performed in parallel.

4. The method of claim 1, wherein the plurality of subdomains are each cross sections of the physical model, and wherein partitioning the physical model comprises scanning the physical model for unique cross sections and identifying each unique cross section as a respective subdomain.

5. The method of claim 1, wherein the TCs indicate how reflected waves are absorbed, and wherein the TCs include (1) first-order TCs (FOTCs) indicating propagating waves being absorbed while evanescent modes being untreated and (2) second-order TCs (SOTCs) indicating propagating waves being absorbed and evanescent modes being treated.

6. The method of claim 5, wherein the FOTCs indicate no absorption for waves that travel tangentially along the physical model.

7. The method of claim 1, wherein a first-order TC and a second-order TC take a form of:
nᵢ\vec{T}ᵢ^{G}+α̅·\vec{u}^{G}=\vec{f}^{G}
nᵢ\vec{T}ᵢ^{G}+α̅·\vec{u}^{G}β̅·∂_{τ}²\vec{u}^{G}=\vec{f}^{G},
wherein α and β are coefficients, \vec{u}^{G} is the generalized mechanical displacement, \vec{T}ᵢ^{G} is the generalized stress tensor.

8. The method of claim 1, wherein solving the global interface system comprises applying a preconditioner on the global interface system that adjusts a conditioning of system matrices and reduces a number of iterations needed to solve the global interface system, the preconditioner being an inverse operation applied on the global interface system.

9. The method of claim 1, wherein the determining of the TCs comprises determining TC coefficients based on a mesh size, interface orientation, and material properties of the AW structure.

10. The method of claim 1, wherein the material properties of the AW structure are anisotropic.

11. A design system for generating an optimized acoustic wave (AW) structure, the design system comprising:
a processor;
a user interface coupled to the processor; and
memory storing a resonator modelling program that, when executed by the processor, causes the design system to perform actions comprising:
receiving, by the user interface, a set of frequency response requirements and a physical model of the AW structure;
partitioning the physical model into a plurality of subdomains that are non-overlapping;
determining and applying transmission conditions (TCs) for each of the plurality of subdomains to couple neighboring subdomains;
reducing a subdomain problem for each subdomain of the plurality of subdomains to a local interface problem;
assembling degrees of freedoms (DOFs) from all local interface problems to form a global interface system;
solving the global interface system by monitoring for convergence accelerated by the applied TCs;
deriving a frequency response of the AW structure at least partially from the solved global interface system;
comparing the frequency response to the set of frequency response requirements; and
optimizing the AW structure based on the comparison to provide an optimized design, the optimized design that is configured as an input to a manufacturing process.

12. The design system of claim 11, wherein factorization and local solution steps of the local interface problem for one subdomain of the plurality of subdomains are independent from factorization and local solution steps of the local interface problem for a different subdomain of the plurality of subdomains.

13. The design system of claim 12, wherein the factorization and local solution steps of the one subdomain and the factorization and local solution steps of the different subdomain are performed in parallel.

14. The design system of claim 11, wherein the plurality of subdomains are each cross sections of the physical model, and wherein partitioning the physical model comprises scanning the physical model for unique cross sections and identifying each unique cross section as a respective subdomain.

15. The design system of claim 11, wherein the TCs indicate how reflected waves are absorbed, and wherein the TCs include (1) first-order TCs (FOTCs) indicating propagating waves being absorbed while evanescent modes being untreated and (2) second-order TCs (SOTCs) indicating propagating waves being absorbed and evanescent modes being treated.

16. The design system of claim 15, wherein the FOTCs indicate no absorption for waves that travel tangentially along the physical model.

17. The design system of claim 11, wherein a first-order TC and a second-order TC take a form of:
nᵢ\vec{T}ᵢ^{G}+α̅·\vec{u}^{G}=\vec{f}^{G}
nᵢ\vec{T}ᵢ^{G}+α̅·\vec{u}^{G}+β̅·∂_{τ}²\vec{u}^{G}=\vec{f}^{G},
wherein α and β are coefficients, \vec{u}^{G} is the generalized mechanical displacement, \vec{T}ᵢ^{G} is the generalized stress tensor.

18. The design system of claim 11, wherein solving the global interface system comprises applying a preconditioner on the global interface system that adjusts a conditioning of system matrices and reduces a number of iterations needed to solve the global interface system, the preconditioner being an inverse operation applied on the global interface system.

19. The design system of claim 11, wherein the resonator modelling program, when executed by the processor, causes the design system to determine the TCs by determining TC coefficients based on a mesh size, interface orientation, and material properties of the AW structure.

20. The design system of claim 11, wherein the material properties of the AW structure are anisotropic.
